(19) United States
(12) Patent Application Publication
(10) Pub. No.: US 2017/0273129 A1
(43) Pub. Date: Sep. 21, 2017

(54) TRANSMISSION APPARATUS AND METHOD OF CONTROLLING THE SAME

(71) Applicant: CANON KABUSHIKI KAISHA, Tokyo (JP)

(72) Inventor: Masatomo Ouchi, Tokyo (JP)

(21) Appl. No.: 15/453,447

(22) Filed: Mar. 8, 2017

(30) Foreign Application Priority Data
Mar. 16, 2016 (JP) 2016-052968

(51) Int. Cl. H04W 76/02; H04W 4/18; H04W 4/06; H04W 8/00

(52) U.S. Cl. CPC H04W 76/023; H04W 76/025; H04W 8/005; H04W 4/18; H04W 4/06

(57) ABSTRACT

In order to solve at least one of the problems that occur if connection cannot be established with some of a plurality of other communication apparatuses, a content transmission apparatus accepts an instruction for content playback using a plurality of other communication apparatuses; determines that communication connection cannot be established with some other communication apparatuses of the plurality of the other communication apparatuses; and performs a predetermined notification to a user in response to determination that the communication connection cannot be established with the some other communication apparatuses of the plurality of the other communication apparatuses.

### BACKGROUND OF THE INVENTION

Field of the Invention

The present invention relates to a transmission apparatus that communicates with a plurality of other communication apparatuses and a method of controlling the transmission apparatus.

Description of the Related Art

In recent years, a technique of displaying by mirroring a display of a small terminal, such as a smartphone, on a large screen by encoding the screen of the small terminal as a video and transmitting the encoded screen to a reception terminal that includes the large screen has become popular. As such a technique, there is Wi-Fi® CERTIFIED Display (WFD). An audio as well as a video can be transmitted by WFD. In International Publication No. 2011/122456, there is disclosed a technique of transmitting an audio or a video from one source apparatus (transmission apparatus) to a plurality of sink apparatuses (reception apparatuses) or from a plurality of source apparatuses to one sink apparatus by using this WFD technique. If such a technique is used, it is possible to create a wireless speaker system using a plurality of sink apparatuses (speaker group).

However, in a wireless speaker system using a plurality of sink apparatuses (speaker group), wireless connection to some of the sink apparatuses in the group may not be established in some cases.

### SUMMARY OF THE INVENTION

The present invention solves at least one problem that occurs in a case in which a transmission apparatus cannot communicate with some of a plurality of other communication apparatuses if the transmission apparatus is to play back a content by using the plurality of other communication apparatuses.

According to one aspect of the present invention, a content transmission apparatus comprising: an accepting unit configured to accept an instruction for content playback using a plurality of other communication apparatuses; a determination unit configured to determine that communication connection cannot be established with some other communication apparatuses of the plurality of the other communication apparatuses; and a notification unit configured to perform a predetermined notification to a user in response to determination by the determination unit that the communication connection cannot be established with the some other communication apparatuses of the plurality of the other communication apparatuses.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a view showing an exemplary configuration of a system that performs one-to-N communication and M-to-one communication;

FIG. 2 is a block diagram showing the hardware configuration of a source apparatus and a sink apparatus;

FIG. 3 is a chart showing a normal sequence in one-to-one connection;

FIGS. 4A and 4B are a view and a table, respectively, showing the configuration of speakers in a 7.1ch audio playback system;

FIG. 5 is a chart showing a sequence according to an operation example 1;

FIG. 6 is a chart showing a sequence according to an operation example 2;

FIG. 7 is a chart showing a sequence according to an operation example 3;

FIG. 8 is a chart showing a sequence according to an operation example 4;

FIGS. 9A and 9B are an operation flowchart according to the operation examples 1 and 3;

FIG. 10 is an operation flowchart according to the operation example 2; and

FIG. 11 is an operation flowchart according to the operation example 4.

### DESCRIPTION OF THE EMBODIMENTS

Preferred embodiments of the present invention will now be described in detail with reference to the accompanying drawings. Note that the following embodiments are merely examples, and the technical scope of the present invention is not limited by the following embodiments.

### First Embodiment

The example of an audio video (AV) system including source apparatuses and sink apparatuses will be used below to describe a communication apparatus according to the first embodiment of the present invention.

<System Configuration>

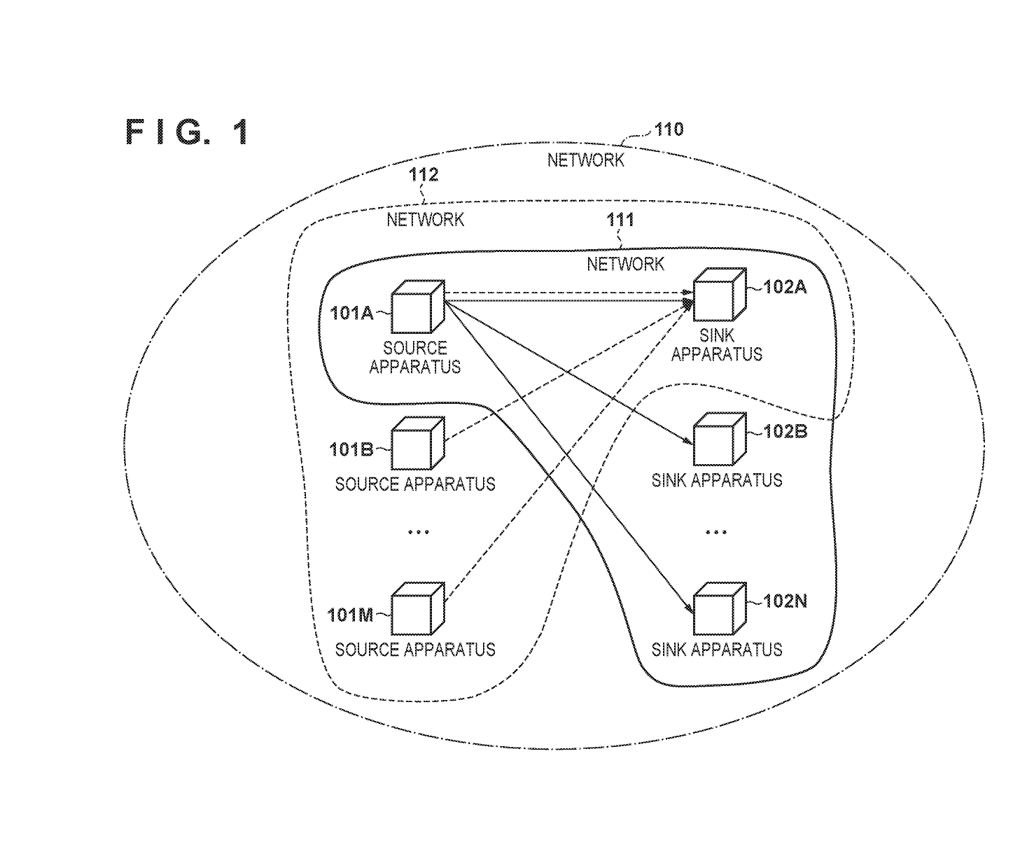

FIG. 1 is a view showing an exemplary configuration of a system that performs one-to-N and M-to-one wireless communication. Here, each of M and N is an integer of one or more. This system includes M source apparatuses 101A to 101M (to also be simply referred to as source apparatuses 101 hereinafter) and N sink apparatuses 102A to 102N (to also be simply referred to as sink apparatuses 102 hereinafter).

Each source apparatus 101 serves as an apparatus on the side transmitting an audio or a video and is configured to be communicably connectable to N sink apparatuses 102. For example, it may be an image capturing apparatus such as a camera or a video camera, an image input apparatus such as a scanner, or a storage device such as a hard disk device or a memory device. The source apparatus may also be an information processing apparatus such as a personal computer (PC) or a smartphone, as a matter of course.

Each sink apparatus 102 serves as an apparatus on the side receiving the audio or the video and is configured to be communicably connectable to N source apparatuses 101. For example, it may be a video output apparatus such as a TV, a display, or a projector or an audio output apparatus such as a speaker.

Note that in the following description, the source apparatuses 101 and the sink apparatuses 102 are described as apparatuses that perform wireless communication in compliance with IEEE802.11 series. Note that, however, they may use wireless communication in compliance with a standard such as Bluetooth®, UWB, ZigBee, or MBOA. Additionally, they may use wired communication such as a wired LAN.

Furthermore, other than direct communication between the source apparatuses 101 and the sink apparatuses 102, the respective apparatuses may be configured so as to communicate with each other via a relay apparatus (not shown) such as an access point. Note that MBOA is an acronym for Multi Band OFDM Alliance. In addition, UWB includes a wireless USB, wireless 1394, and WINET.

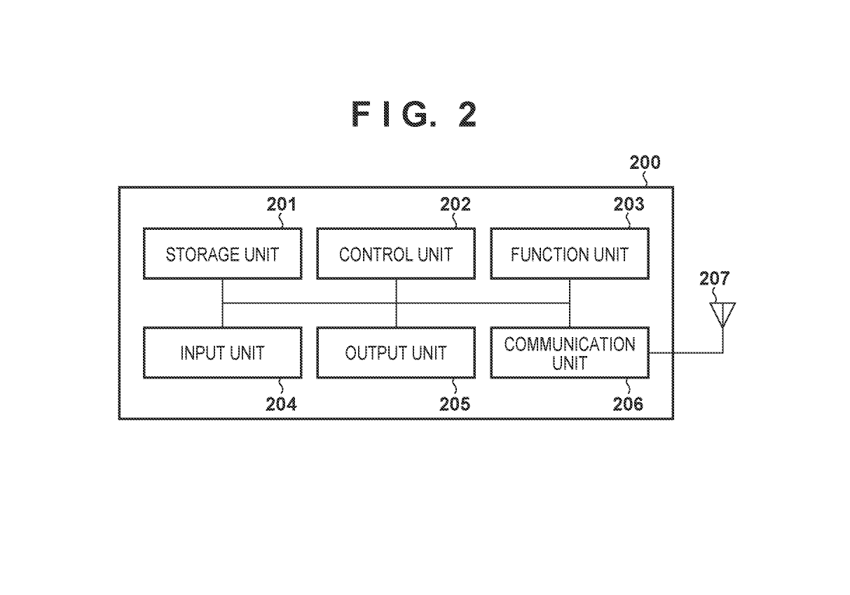

FIG. 2 is a view showing the hardware configuration of a communication apparatus 200 that operates as a source apparatus 101 or a sink apparatus 102.

A storage unit 201, which is formed from a memory such as a ROM or a RAM, stores programs to perform various kinds of operations (to be described later) and various pieces of information such as communication parameters for wireless communication. Note that other than a memory such as a ROM or a RAM, a storage medium such as a flexible disk, a hard disk, an optical disk (CD, DVD), a magnetooptical disk, a magnetic tape, or a nonvolatile memory card may be used as the storage unit 201. The storage unit 201 may include a plurality of memories.

A control unit 202, which is formed from a processor such as a CPU or an MPU, controls the entire communication apparatus 200 by executing programs stored in the storage unit 201. Note that the control unit 202 may control the entire communication apparatus 200 in cooperation with an OS (Operating System) and the programs stored in the storage unit 201. The control unit 202 may also include a plurality of processors such as a multi-core and control the entire communication apparatus 200 by the plurality of processors. The control unit 202 controls a function unit 203 (to be described later) to execute predetermined processes such as image capturing, printing, and projecting.

The function unit 203 is hardware to execute predetermined processes. For example, in a case in which the communication apparatus 200 operates as the source apparatus 101, the function unit 203 includes an image encoding function and an image capturing function such as a camera. In a case in which the communication apparatus 200 operates as the sink apparatus 102, the function unit 203 includes an image decoding function and a display function such as a display. Additionally, the data to be processed by the function unit 203 may be data stored in the storage unit 201 or data acquired from communicating with another communication apparatus via a communication unit 206.

An input unit 204 accepts various kinds of operations from a user. An output unit 205 makes various kinds of outputs to the user. Here, an output by the output unit 205 includes at least one of display onto a screen, an audio output by a speaker, and a vibration output. Note that the input unit 204 and the output unit 205 may be implemented together as a single module such as a touch panel.

The communication unit 206 controls IP communication and wireless communication in compliance with the IEEE802.11 series. In addition, the communication unit 206 controls an antenna 207 to transmit/receive wireless signals for wireless communication. Each source apparatus 101 transmits a content such as image data, document data, or audio video data to each sink apparatus 102 via the communication unit 206.

<Basic Operation of Communication Apparatus 200>

Basic Sequence Between Source Apparatus and Sink Apparatus

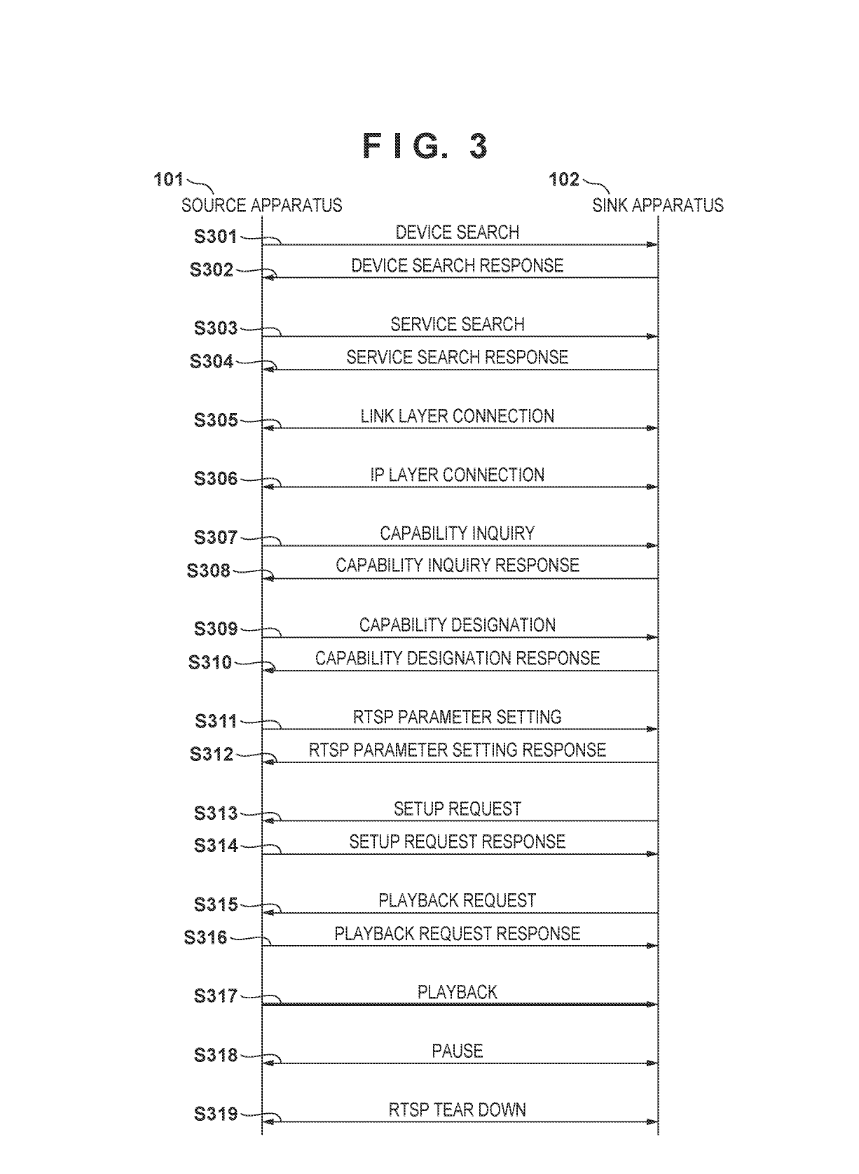

FIG. 3 is a chart showing a normal sequence between a source apparatus and a sink apparatus in one-to-one connection. More specifically, it shows the operation from an apparatus search to service execution between one source apparatus and one sink apparatus implemented by separate communication apparatuses 200, respectively. Note that this case shows an example of a sequence between apparatuses in compliance with a WFD standard.

In step S301, the source apparatus 101 transmits a search packet for device search. Note that the search packet may be a broadcast packet or a unicast packet. In step S302, the sink apparatus 102 receives the search packet and transmits a response packet to the search packet. Here, the response packet includes a device name, a link address of the device, and a device type of the sink apparatus 102.

In this case, a device type is either “Source”, “Primary Sink”, “Secondary Sink”, or “Dual Role (both Source and Sink)”.

In step S303, the source apparatus 101 transmits a search packet for service search. In step S304, the sink apparatus 102 receives the search packet and transmits a response packet to the search packet. At this time, the sink apparatus 102 includes service information that can be provided in this response packet.

Here, the service information is either “Send” for file transfer, “Print” for printing, “Play” for audio video streaming, “Display” for mirroring, or “Other”.

A “service” and a “role” in the service are determined between the two apparatuses by the aforementioned procedure. A description about the roles will be given later.

In step S305, the source apparatus 101 and the sink apparatus 102 perform link layer connection. This procedure includes IEEE802.11 standard authentication, association, and Group Owner (GO) negotiation of Wi-Fi Direct.

In step S306, the source apparatus 101 and the sink apparatus 102 perform IP layer (Internet Protocol) connection. Here, if the apparatuses are connected by Wi-Fi Direct, the apparatus serving as GO causes a DHCP server function to operate and assigns the IP address of a corresponding client apparatus.

In step S307, the source apparatus 101 transmits a packet to the sink apparatus 102 to inquire of the sink apparatus 102 of its capability concerning service execution.

In step S308, the sink apparatus 102 transmits a response packet to the capability inquiry. Here, the response packet includes detailed information about a service that the sink apparatus 102 can provide. If the sink apparatus 102 is a display or a projector and “Display” is the service that can be provided, a decoding capability, a resolution, and the like are included as the detailed information. On the other hand, if the sink apparatus 102 is a speaker, a role and a position are included as the detailed information. Here, roles are “Front (front)”, “SubWoofer (subwoofer)”, “Center (center)”, “Surround (surround or rear)”, “Surround.Back (surround back)” and the like. A position is “right” or “left”. Note that the sink apparatus 102 can respond a plurality of pieces of information as the roles that can be provided such as “Surround” and “Surround.Back”.

In step S309, the source apparatus 101 transmits a capability designation to designate the capability of the sink apparatus 102. In step S310, the sink apparatus 102 responds to the received capability designation. Note that this procedure can be performed at an arbitrary timing. Accordingly, for example, it is possible to cause a sink apparatus that started to temporarily operate as “Surround.Back” to operate as “Surround”.

In step S311, the source apparatus 101 transmits parameter settings for an RTSP procedure. In step S312, the sink apparatus 102 receives the parameter setting and returns a response. In step S313, the source apparatus 101 transmits a SETUP (setup) for the RTSP procedure. In step S314, the sink apparatus 102 receives the SETUP (setup) and returns a response.

In step S315, the source apparatus 101 performs playback request of the RTSP procedure. In step S316, the sink apparatus 102 returns a response to the playback request. At this point, the sink apparatus 102 has become prepared to play back the audio or the video streaming data from the source apparatus 101.

Note that in the following description, a procedure performed between the communication apparatuses after connection by the link layer may be expressed as a session.

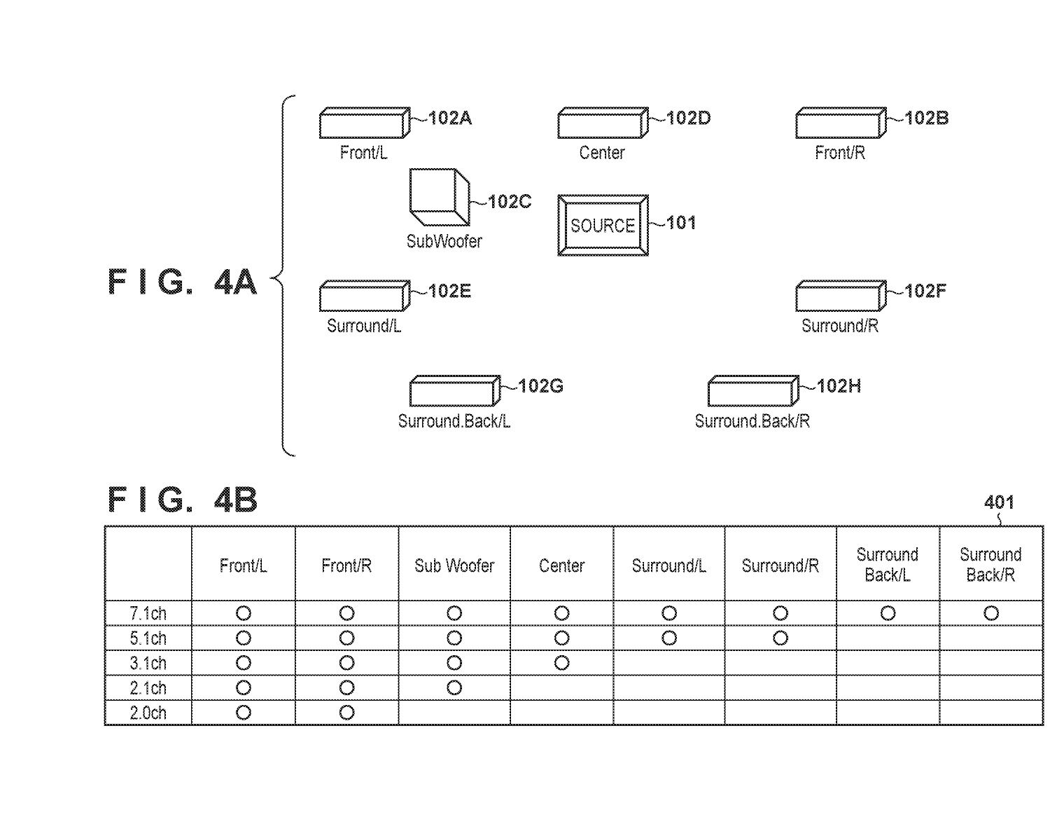

FIG. 4A is a view showing the configuration of speakers in a 7.1ch audio playback system by wireless communication. This corresponds to a case in which N=8 in a one-to-N network 111 of FIG. 1.

The source apparatus 101 includes a content such as music. The sink apparatus 102A is a Front/L (front left) speaker, and the sink apparatus 102B is a Front/R (front right) speaker. These two apparatuses play back sounds from the front. In the same manner hereinafter, the sink apparatus 102C is a SubWoofer (subwoofer) speaker, and the sink apparatus 102D is a Center (center) speaker. In addition, the sink apparatus 102E is a Surround/L (surround left) speaker, and the sink apparatus 102F is a Surround/R (surround right) speaker. The sink apparatus 102G is a Surround.Back/L (surround back left) speaker, and the sink apparatus 102H is a Surround.Back/R (surround back right) speaker.

FIG. 4B shows a configuration table 401 showing the necessary configuration of the audio playback system. The configuration table 401 defines a plurality of combinations of speakers necessary for audio playback. In this case, speaker combinations necessary for playback in 7.1ch, 5.1ch, 3.1ch, 2.1ch, and 2.0ch have been defined. Here, a single row or a combination of plurality of rows is called service configuration information or a service profile. The configuration table 401 is held in the storage unit 201. In addition, a user of the source apparatus 101 can change these pieces of service configuration information via the input unit 204.

### Operation Examples

Operation examples according to the above-described configuration will be described below. Particularly, in operation examples 1 to 3, an audio playback configuration setting change operation in a case in which session establishment cannot be completed with some of the sink apparatuses of a plurality of sink apparatuses will be described. In addition, an operation example 4 will describe a connection setting change operation for a multiplayer game in which the number of source apparatuses connected to one sink apparatus is changed during a game.

### Operation Example 1: Case in which Connection Procedure Cannot be Completed with Some of Speakers

Control for a case in which connection with one of the speakers cannot be established if a playback in 7.1ch by 8 speakers has been instructed will be described as the operation example 1. More specifically, an example of performing 5.1ch playback which can be configured by the 7 speakers that have established connection will be described. Assume that the system configuration is the 7.1ch audio playback (content playback) system shown in FIGS. 4A and 4B.

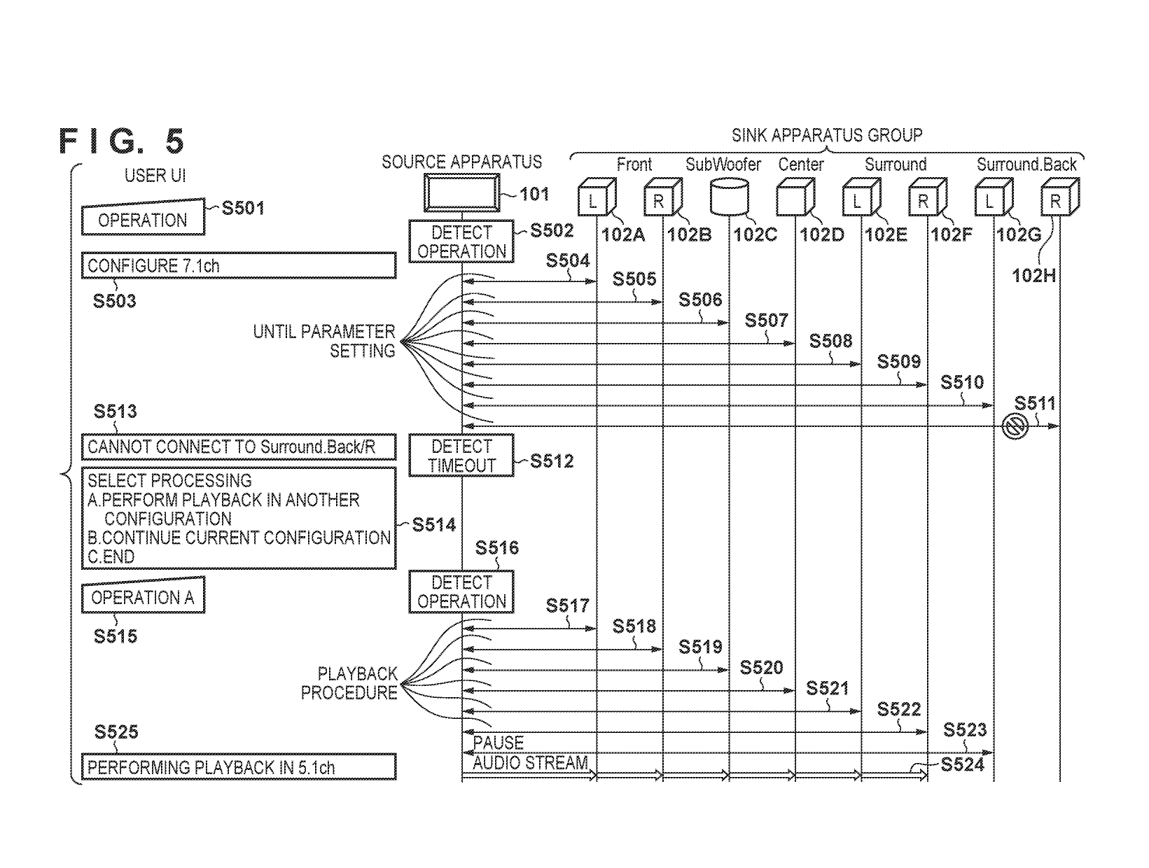

FIG. 5 is a chart showing a sequence according to the operation example 1. FIG. 5 shows, from the left side of the drawing, a UI (user interface) that accepts an operation from the user, a source apparatus serving as a communication apparatus, and a sink apparatus group (8 speakers) serving as a plurality of external communication apparatuses, and the control between the apparatuses is shown.

In step S501, the source apparatus 101 displays a GUI that accepts an operation from the user. In this case, the user designates “7.1ch” as the “service configuration information (profile)”. For example, the user can make a selection by pressing a button displayed as a GUI. Note that instead of designating the service configuration information (profile), the user may simply designate the number of sink apparatuses. In step S502, the source apparatus 101 detects that “7.1ch” has been designated. In step S503, the source apparatus 101 displays “Configuring 7.1ch” on the output unit 205.

In step S504, the source apparatus 101 performs the procedure from steps S301 to S312 in FIG. 3 with the sink apparatus 102A (Front/L). In the following description, assume that the execution of these procedural steps will be written as “until parameter setting”. Subsequently, in steps S505 to S510, the procedure “until parameter setting” is completed in the same manner for each of the other 5 speakers from Front/R to Surround.Back/L.

In step S511, the source apparatus 101 tries to perform the procedure “until parameter setting” with the sink apparatus 102H (Surround.Back/R). However, in this case, RTSP parameter setting is incomplete. In step S512, the source apparatus 101 detects the timeout of the RTSP parameter setting and determines that the procedure “until parameter setting” has failed. Note that this determination of the failure of the procedure “until parameter setting” is not limited to a timeout and may be determined by the occurrence of a protocol error such as an invalid value response or an invalid procedure.

In step S513, the source apparatus 101 displays “Cannot connect to surround back right” on the output unit 205 to indicate that it could not proceed with the procedure “until parameter setting” with the sink apparatus 102H (Surround.Back/R). That is, it notifies the user of the error. In step S514, the source apparatus 101 displays control options for this situation to cause the user to make a selection. Here, as the options, the source apparatus displays “(A) Perform playback in another configuration”, “(B) Continue current configuration”, and “(C) End”.

In this case, although a specific description will be given later, option (A) represents the choice to execute playback by another configuration (such as “5.1ch”) by using the 7 sink apparatuses that have completed the procedure until parameter setting. Option (B) represents the choice to proceed in accordance with the initially designated playback procedure by using the 7 sink apparatuses that have completed the procedure until the setting of the parameters. That is, in this case, the Surround.Back on the “right” will not be played back, and only that on the “left” will be played back.

Option (C) represents the choice to end the process by discarding the procedure performed with the sink apparatuses up to that point. For example, in order to end the process, TEAR DOWN (disconnection) of RTSP procedure, disconnection of the IP layer, or disconnection of the link layer can be used. Note that before executing each disconnection, RTSP PAUSE (pause) can be performed.

In step S515, the source apparatus 101 accepts the selection (operation instruction) of one of the options from the user. In this case, assume that the user has selected option (A). In step S516, the source apparatus 101 recognizes that option (A) has been selected as a result of inquiry to the user.

Accordingly, the source apparatus 101 determines a configuration to replace the “7.1ch” configuration initially instructed by the user. In this determination, a configuration is automatically selected in accordance with the configurations registered in the configuration table 401 and the current status of connection with the sink apparatuses. More specifically, a configuration in which a playback can be performed normally by using a combination of the currently connected sink apparatuses will be selected.

For example, referring to the configuration table 401, “2.0ch”, “2.1ch”, “3.1ch”, and “5.1ch” are the configurations in which a normal playback can be performed by using the aforementioned 7 speakers. Accordingly, “5.1ch” which is the configuration that can perform playback in a manner most similar to that of “7.1ch” designated by the user is selected. Note that another configuration may be automatically selected or it may be configured so as to accept the selection made by the user. A description of a case in which the “5.1ch” configuration has been selected will be given hereinafter.

In steps S517 to S522, of the 7 wirelessly connected speakers, a RTSP playback procedure is executed to 6 speakers (sink apparatuses 102A to 102F). On the other hand, in step S523, the source apparatus 101 executes the RTSP PAUSE (pause) procedure to one speaker (sink apparatus 102G) of the 7 wirelessly connected speakers. That is, control is performed so as to perform content playback by a configuration using 6 (L) sink apparatuses, which are less than 7, while continuing communication connection with the 7 (N) sink apparatuses, of all the 8 (M) sink apparatuses, that have established communication connection. Subsequently, pause control is performed in one (N-L) of the sink apparatuses.

In step S524, the source apparatus 101 transmits each role (channel) in the audio stream to each of the corresponding sink apparatuses 102A to 102F. In step S525, the source apparatus 101 displays “Performing playback in 5.1ch” on the output unit 205.

Note that in step S524, the roles (channels) of the audio stream can be, for example, multiplexed by MPEG-TS and transmitted. That is, the same data (multiplexed stream) may be sent to all of the sink apparatuses, and each sink apparatus may extract and play back the data of its role (channel). Additionally, at this time, in step S523, a playback procedure may be performed with the sink apparatus 102G, and it may be configured so as not to multiplex the data for the sink apparatus 102G.

In any case, no sound is played back from the sink apparatus 102G, and 5.1ch playback is performed by 6 speakers (sink apparatuses 102A to 102F). By performing control in this way, it is possible to prevent audio playback in, for example, an imbalanced situation where sound is output from only one of the pair of left and right speakers.

Note that the selection of service configuration information in accordance with the circumstance is not limited to simply removing “only a pair of speakers” as a playback target. For example, “Center”, “Surround”, and “Surround.Back” are removed as playback targets if the procedure “until parameter setting” is not completed between the source apparatus and the SubWoofer, and “2.0ch” is set as the configuration. In either case, the configuration is preferably selected in accordance with the wirelessly connected speakers and the sets of speakers used in each configuration defined in the configuration table 401.

According to this selection method, if the procedure “until parameter setting” is not completed between the source apparatus and the “Center”, two (that is, multiple) configurations, “2.0ch” and “2.1ch”, become candidates. In this case, the “2.1ch” configuration which is closer to the “7.1ch” configuration initially requested by the user is prioritized and selected.

In this manner, according to the operation example 1, even in a case in which connection cannot be established with some of the plurality of sink apparatuses to be used in the configuration designated by the user, it is possible to perform playback with little sense of incongruity. That is, it can implement, with little operation and control procedure by the user, balanced playback by a configuration close to the configuration intended by the user. In addition, since an already established session with each speaker is used, there is no mandatory wait time for the user.

### Operation Example 2: Subsequent Control During Playback after Operation Example 1

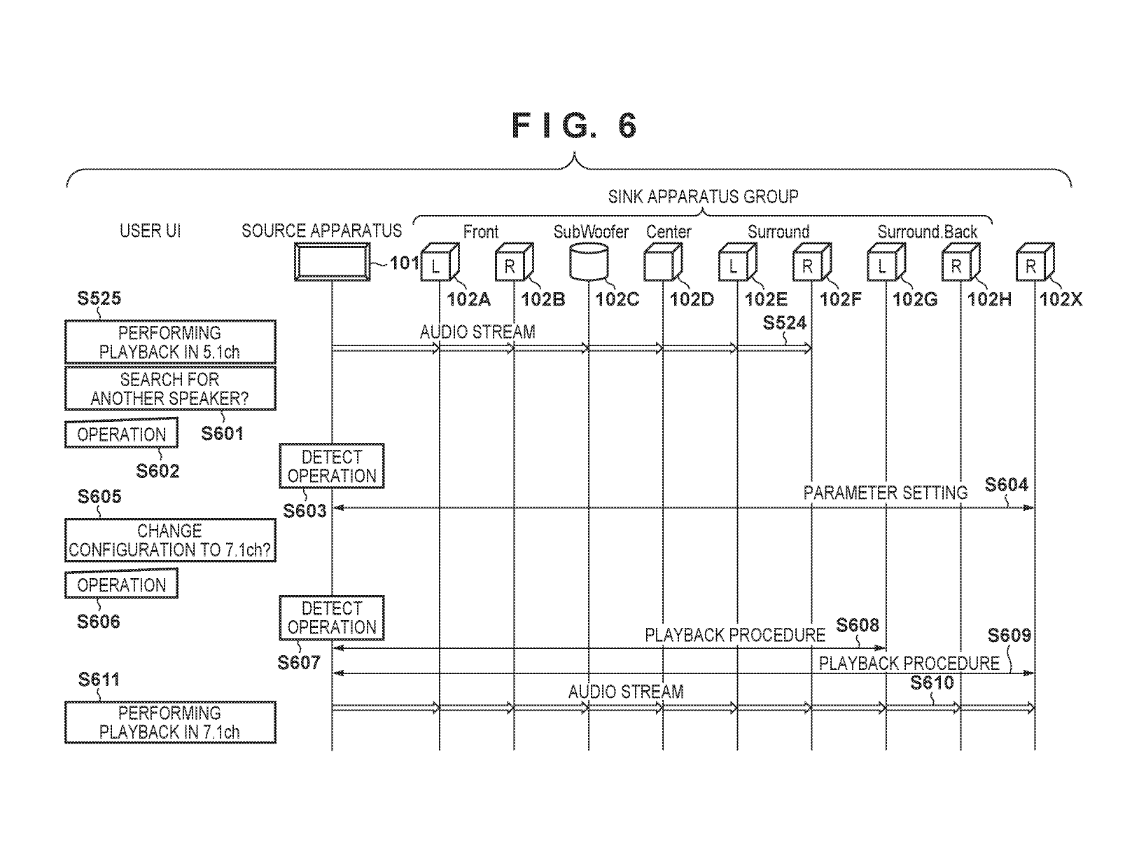

In the operation example 2, an operation that succeeds the operation example 1, more specifically, an operation of switching the configuration to playback in 7.1ch while playback in 5.1ch is being performed will be described. FIG. 6 is a chart showing a sequence according to the operation example 2.

In step S601, to inquire of the user about whether to perform control for “Surround.Back/R search”, the source apparatus 101 displays “Search for another speaker?” or “Attempt 7.1ch connection?” on the output unit 205. In step S602, the source apparatus 101 accepts an operation by the user. Here, assume that the user made an operation to select “Yes”. In step S603, the source apparatus 101 detects the operation by the user and starts a sink apparatus search. In this case, assume that a new sink apparatus 102X is in a state in which it can operate as a speaker.

In step S604, the source apparatus 101 completes the procedure “until parameter setting” with the sink apparatus 102X. This procedure “until parameter setting” is processing of procedural steps from step S301 to S312 of FIG. 3 as described above.

In step S605, the source apparatus 101 displays “Change to 7.1ch?” as an inquiry to the user. In step S606, the source apparatus 101 accepts the operation made by the user. Here, assume that the user made an operation to select “Yes”. In step S607, the source apparatus 101 detects the operation by the user. Note that after the completion of step S604, it may be configured so as to perform again the determination as to whether connection with the 8 sink apparatuses to be used for the 7.1ch playback has been established.

In step S608, the source apparatus 101 executes the RTSP playback procedure with the sink apparatus 102G. In step S609, the source apparatus 101 executes the RTSP playback procedure with the sink apparatus 102X. In step S610, the source apparatus 101 newly transmits audio streams (Surround.Back/L and Surround.Back/R) to the sink apparatuses 102G and 102X. In step S611, the source apparatus 101 displays “Performing playback in 7.1ch” on the output unit 205.

Note that if the sink apparatus 102H is detected in the search in step S603, the source apparatus may connect to the sink apparatus 102H instead of the sink apparatus 102X. Furthermore, if TEAR DOWN with an arbitrary sink apparatus is detected during playback, it is possible to perform control of “search for an apparatus”.

In this manner, according to the operation example 2, it is possible to change to playback in another configuration while playback is being performed in a given configuration, with little operation and control procedure by the user. Particularly, since an already established session with a speaker is used, it is possible to quickly change to a new configuration.

### Operation Example 3: Changing Roles of Speakers

In the operation example 3, a case in which connection cannot be established with one speaker if 7.1ch playback by 8 speakers has been instructed will be described. However, unlike the operation example 1, an operation for a case where connection with the sink apparatus 102F (“Surround/R” speaker) cannot be established is shown.

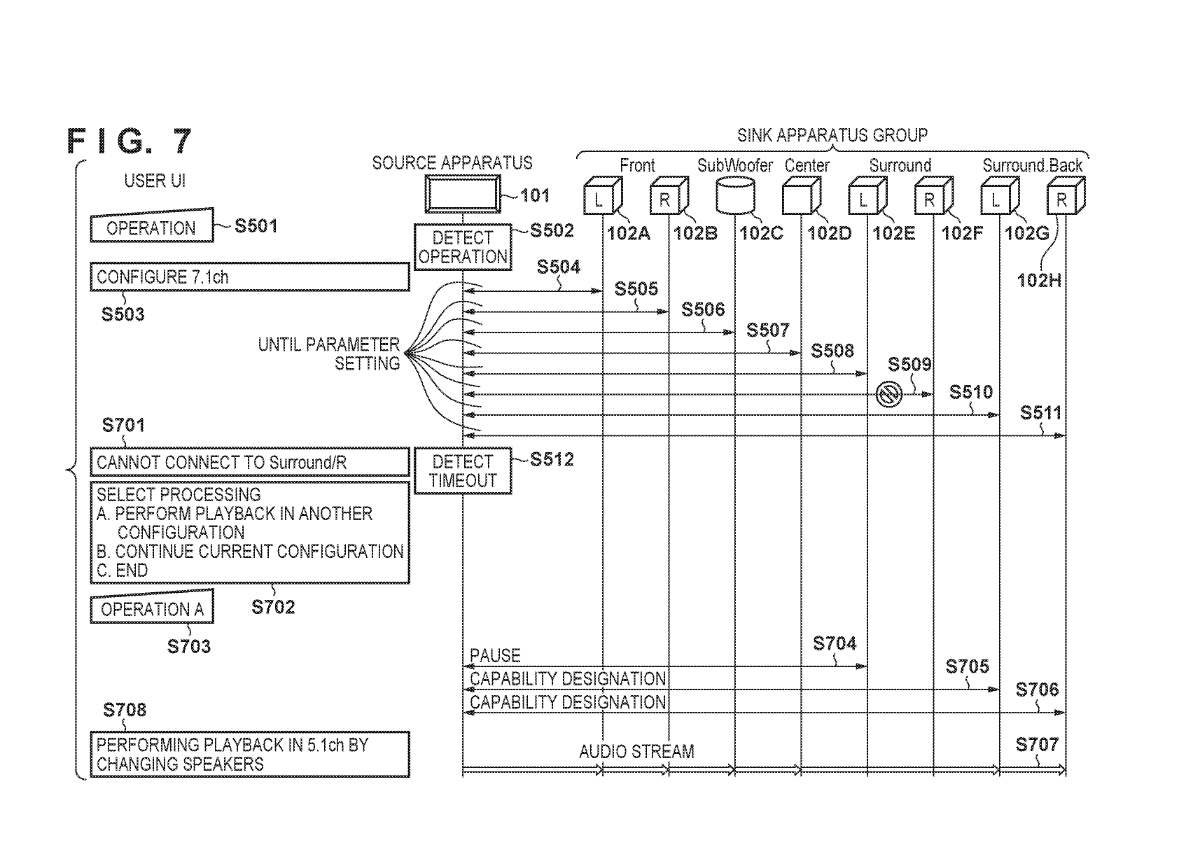

FIG. 7 is a chart showing a sequence according to the operation example 3. Steps S501 to S512 are the approximately the same as those in FIG. 5. However, as described above, it is different from the operation example 1 in that the procedure “until parameter setting” is incomplete between the source apparatus and the sink apparatus 102F (“Surround/R” speaker).

That is, the timeout in step S512 is a state of timeout in the procedure with the sink apparatus 102F. This state is due to the fact that the source apparatus 101 performs the procedures with the respective sink apparatuses in parallel.

Furthermore, in the operation example 3, the source apparatus 101 has already confirmed that each of the sink apparatuses 102G and 102H includes two roles as a capability. More specifically, the sink apparatus 102G can operate in either of the two roles, “Surround/L” or “Surround.Back/L”. The sink apparatus 102H can operate in either of the two roles, “Surround/R” or “Surround.Back/R”. That is, the source apparatus 101 knows that the sink apparatuses 102G and 102H are capable of changing their respective roles.

In step S701, the source apparatus 101 displays “Cannot connect to Surround/R” on the output unit 205 to indicate that the procedure “until parameter setting” could not be completed with the sink apparatus 102H serving as the “Surround/R”. In step S702, the source apparatus 101 performs display to cause the user to select control for this situation. The options are “(A) Perform playback in another configuration”, “(B) Continue current configuration”, or “(C) End”.

In step S703, the source apparatus 101 accepts a selection of the aforementioned options from the user. Here, the selection of option (A) is detected.

However, in this case, since connection to the “Surround/R” is incomplete and not possible, if the same control as that in the operation example 1 is performed, the “3.1ch” configuration will be selected based on the configuration table 401. In such a case, the two “Surround.Back” speakers which are already connected will be unused and wasted. Hence, in the operation example 3, the roles of the two speakers connected as “Surround.Back” are changed to “Surround”, and “5.1ch” playback is performed.

In step S704, the source apparatus 101 executes, to the sink apparatus 102E, an RTSP PAUSE (pause) procedure. On the other hand, in step S705, the source apparatus 101 performs a capability setting procedure to the sink apparatus 102G. In this case, “Surround/L” is designated instead of the initially designated “Surround.Back/L”. In the same manner, in step S706, the source apparatus 101 performs a capability setting procedure to the sink apparatus 102H. In this case, “Surround/R” is designated instead of the initially designated “Surround.Back/R”.

In step S707, the source apparatus 101 transmits the roles (channels) of the audio stream to the corresponding sink apparatuses 102A to 102D, 102G, and 102H, respectively. In step S708, the source apparatus 101 displays “Performing 5.1ch playback by changing speakers” on the output unit 205.

Note that speaker role change is not limited to changing “Surround.Back” to “Surround”. That is, various changes are possible in accordance with the configuration table 401 and the executable roles and positions of the speakers.

In this manner, according to the operation example 3, even in a case in which connection cannot be established with some of the plurality of sink apparatuses to be used in the configuration designated by the user, it is possible to perform playback with little sense of incongruity. Particularly, more realistic playback is possible by maximizing the use of already established connection with the speakers.

### Operation Example 4: Operation in Multiplayer Game

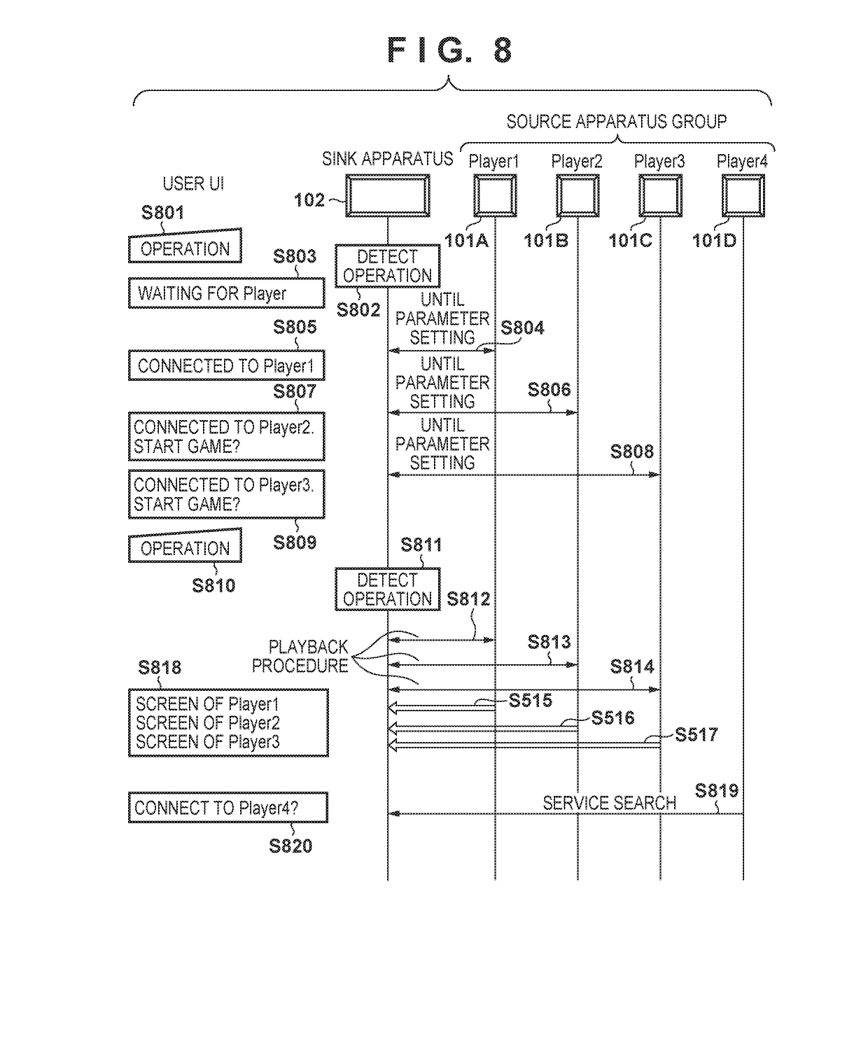

FIG. 8 is a chart showing a sequence according to the operation example 4. Here, the case of a multiplayer game in which the screens of a plurality of source apparatuses (tablet terminals) are displayed in one sink apparatus (large display) is assumed. In FIG. 8, from the left side of the drawing, a UI (user interface) that accepts an operation from the user, a sink apparatus, and a source apparatus group (four apparatuses) are shown, and control between the apparatuses is shown.

In other words, FIG. 8 corresponds to a case in which M=4 in an M-to-one network 112 of FIG. 1. However, unlike the operation examples 1 to 3, assume that there is no predetermined connection configuration and that the number of apparatuses configuring the game is also arbitrary.

In step S801, the sink apparatus 102 displays the GUI to start accepting participation to the game and accepts the operation from each user. In step S802, the sink apparatus 102 detects an operation to start accepting participation to the game.

In step S803, the sink apparatus 102 displays “Waiting for Player”. At the same time, the sink apparatus waits for a device search from the source apparatus and/or transmits a notification that a game service is being activated. For example, a beacon signal indicating that the device type is “Sink” or an “advertise” packet indicating that a “Display” service is executable is transmitted.

In step S804, the sink apparatus 102 performs the procedure “until parameter setting” with the source apparatus 101A. Then, in step S805, the sink apparatus 102 displays “Connected to Player1”. However, since there is only one game participant at this point, the sink apparatus 102 continues to stand by to accept participation to the game.

In step S806, the sink apparatus 102 performs the procedure “until parameter setting” with the source apparatus 101B. Then, in step S807, the sink apparatus 102 displays “Connected to Player2. Start game?” That is, since there are now two or more game participants, the sink apparatus 102 notifies the users that the start of the game will be accepted. In the same manner, in step S808, the sink apparatus 102 performs the procedure “until parameter setting” with the source apparatus 101C. Then, in step S809, the sink apparatus 102 displays “Connected to Player3”.

In step S810, the sink apparatus 102 displays the GUI for instructing the start of the game and accepts the operation from each user. In step S811, the sink apparatus 102 detects each operation to start the game. Along with this, in steps S812 to S814, the sink apparatus 102 executes a playback procedure with each of the source apparatuses 101A to 101C.

In step S815 to S817, the source apparatuses 101A to 101C each transmit an audio or video to the sink apparatus 102. In step S818, the sink apparatus 102 plays back the audio or video received from each of the source apparatuses 101A to 101C. That is, the audio playback or screen display is performed in the output unit 205.

In step S819, the source apparatus 101D performs a service search for the game in accordance with the game start operation made by a user (Player4) of the source apparatus 101D. In step S820, the sink apparatus 102 displays on the output unit 205 “Connect to Player4?”

In this manner, according to the operation example 4, the operability can be improved in the case of a multiplayer game, since it is possible to proceed with the procedural steps until playback without designating beforehand the number of opposing communication partners.

In the above-described operation examples 1 to 4, descriptions were given assuming IP layer communication (DHCP control and RTSP control) based on a Wi-Fi Direct standard. However, it may be configured to perform control that targets link layer communication.

<Operation Flowchart of Communication Apparatus 200>

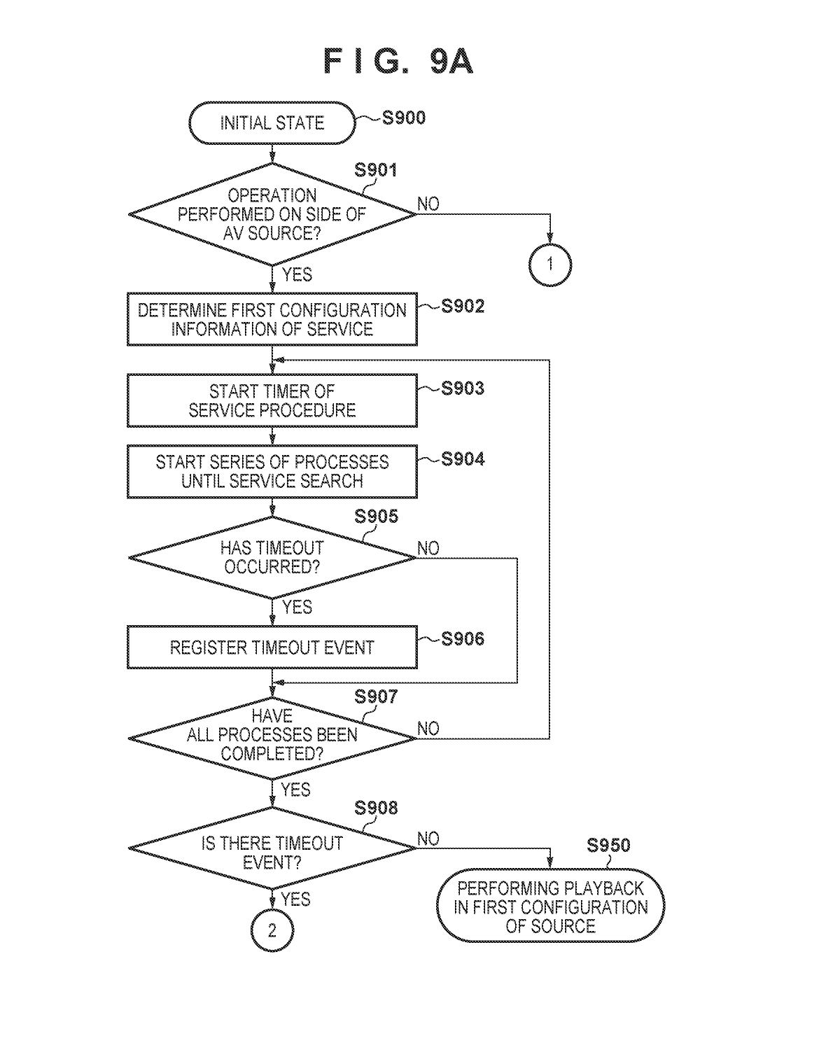

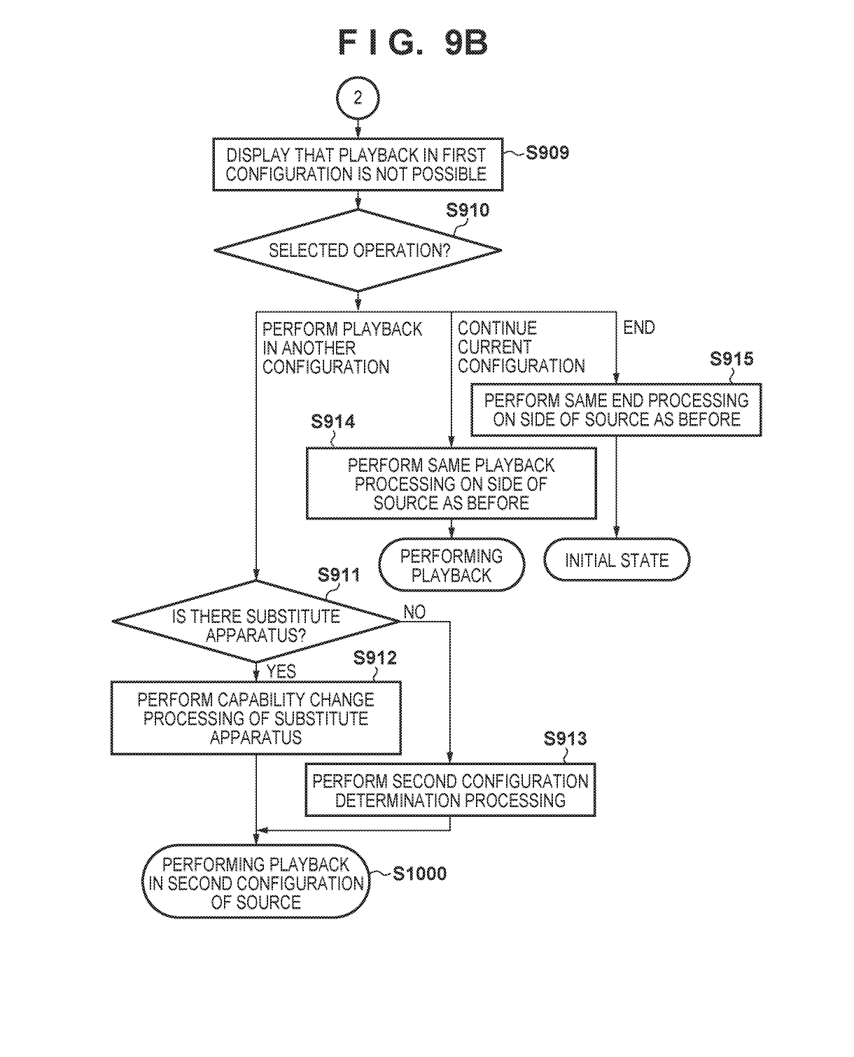

FIGS. 9A and 9B are an operation flowchart of a case in which the communication apparatus 200 operates as the source apparatus. It corresponds to the aforementioned descriptions about the operation of the source apparatus given in the operation examples 1 and 3. That is, the operation of the source apparatus described in FIGS. 5 and 7 has been written in a flowchart format. The flowchart of FIGS. 9A and 9B shows a processing sequence implemented in the communication apparatus 200 if the control unit 202 reads out a program stored in the storage unit 201 and executes the program.

In step S900, the communication apparatus 200 is in an initial state. Here, it is shown that the communication apparatus 200 has a “Dual Role”, that is, it includes functions of both the source apparatus and the sink apparatus. For example, it is a device such as a notebook PC or a tablet terminal capable of executing operations as an audio or video transmission-side device and as an audio or video reception-side device.

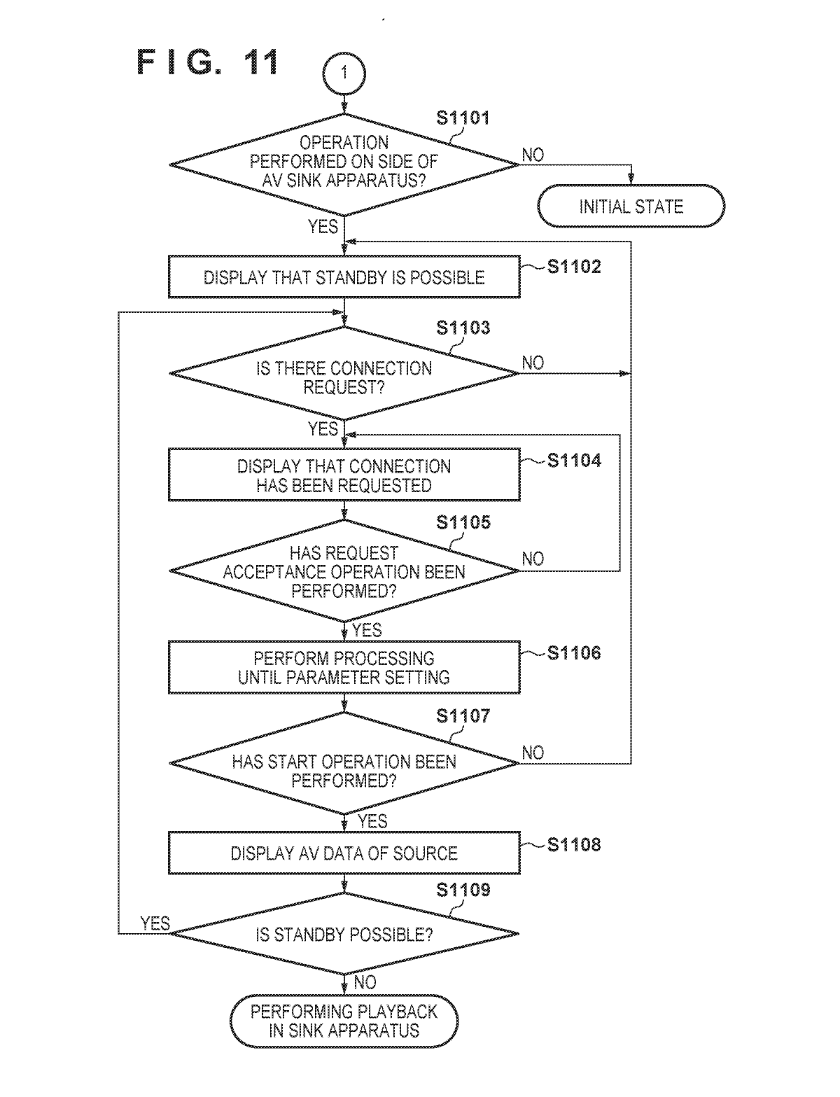

In step S901, the communication apparatus 200 determines whether the user has made an operation to start an operation as the source apparatus of an audio or video (AV) service. If it is determined that an operation to start operating as a source apparatus is determined, the process advances to step S902. Otherwise, the process advances to the flowchart of FIG. 11 (to be described later).

In step S902, if it is to operate as a source apparatus, the communication apparatus 200 determines the service configuration information of the sink apparatus group and sets the determined information as “the first configuration information of the service”.

In step S903, the communication apparatus 200 starts the timer of the service procedure. Here, other than the standard procedures such as RTSP, DHCP, Wi-Fi Direct, the service procedure also includes procedures uniquely determined between the source apparatus and the sink apparatuses. In step S904, the communication apparatus 200 starts the above-described series of processes “until parameter setting”.

In step S905, the communication apparatus 200 confirms whether a timeout has occurred in the service procedure started in step S903. If a timeout has occurred, the communication apparatus 200 registers the occurrence of a timeout event in the storage unit 201 in step S906.

In step S907, the communication apparatus 200 determines whether the procedure “until parameter setting” has ended for every sink apparatus included in the service configuration information. Here, the end of the procedure “until parameter setting” represents that the procedure until step S312 has ended or a timeout has occurred between the communication apparatus and the sink apparatuses. If the procedure has not ended for every sink apparatus, the process returns to step S903. Otherwise, the process advances to step S908.

In step S908, the communication apparatus 200 confirms whether a timeout event has occurred. If no timeout has occurred, it indicates that connection has been normally established with all of the sink apparatuses, and the process advances to a state performing audio or video playback. This state will be referred to “performing playback in the first configuration of a source” (step S950). On the other hand, if time out has occurred, the process advances to step S909.

In step S909, the communication unit 200 displays “playback is not possible in the first configuration”. This step corresponds to steps S513 and S701. In step S910, the communication apparatus 200 accepts the selection made by the user. That is, the communication apparatus accepts, from the user, an operation to either “(A) Perform playback in another configuration”, “(B) Continue current configuration”, or “(C) End”. This step corresponds to steps S514 and S702.

If the selection of “(A) Perform playback in another configuration” is detected, in step S911, the communication apparatus 200 determines whether a sink apparatus that can be a substitute for the apparatus which could not complete the procedure “until parameter setting” is present in the sink apparatus group that has completed the procedure “until parameter setting”. If such an apparatus is present, the process advances to step S912. Otherwise, the process advances to step S913.

In step S912, the communication apparatus 200 changes the capability of the substitute sink apparatus. This corresponds to steps S705 and S706. On the other hand, in step S913, the communication apparatus 200 advances to the playback procedure without changing the capability of the apparatus. This corresponds to steps S517 to S523.

The process advances, after either step S912 or step S913, to a state of “performing playback in the second configuration of the source” (step S1000).

Note that if the selection to “(B) Continue current configuration” is detected in step S910, in step S914, the playback processing (data transmission processing) of the source apparatus is performed as before. Furthermore, in step S910, if the selection to “(C) End” is detected, the playback processing in the source apparatus ends.

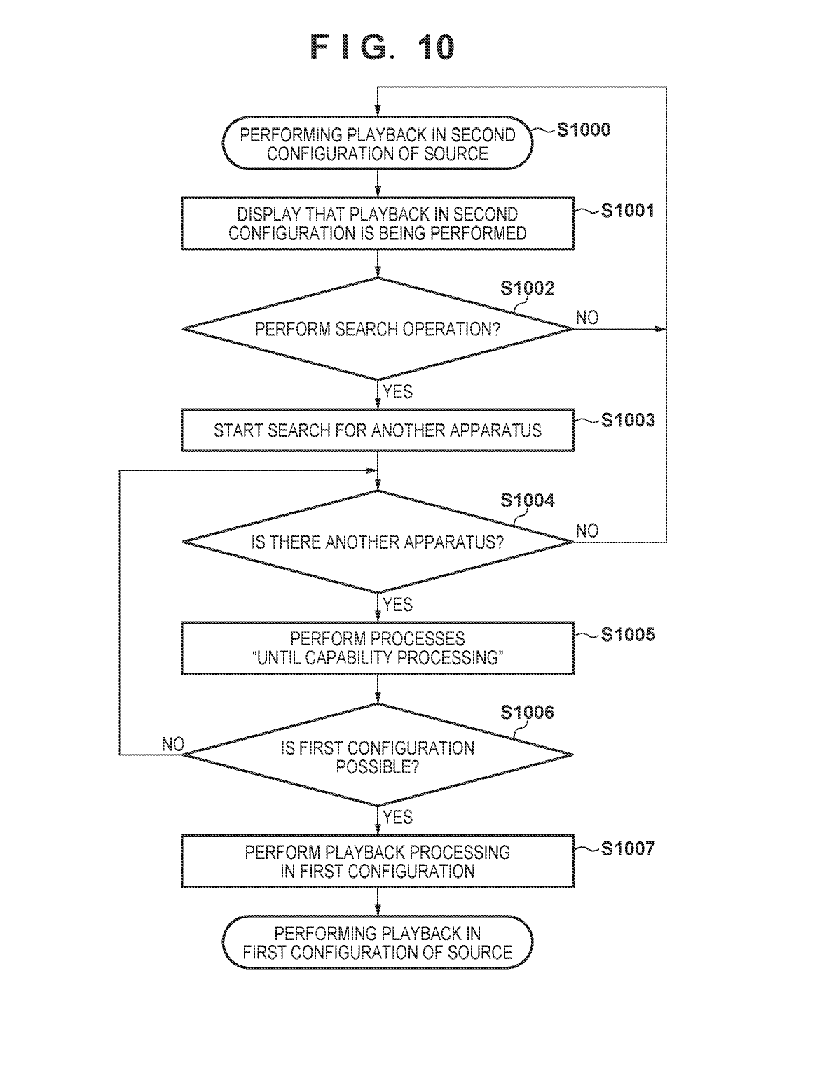

FIG. 10 is an operation flowchart of a case in which the communication apparatus 200 operates as a source apparatus. It corresponds to the aforementioned description about the operation of the source apparatus given in the operation example 2. That is, the operation of the source apparatus described in FIG. 6 has been written in a flowchart format.

In step S1000, the communication apparatus 200 is in a state of “performing playback in the second configuration of the source”. Here, “the second configuration” does not represent the configuration (“7.1ch” in the aforementioned example) initially designated by the user, but represents another configuration such as “5.1ch”.

In step S1001, the communication apparatus 200 displays “performing playback in the second configuration of the source”. This corresponds to steps S525 and S708. In step S1002, the communication apparatus 200 detects an operation, from the user, to start a search for another apparatus. In step S1003, upon detecting the operation to start a search, the communication apparatus 200 starts the search for another apparatus. In step S1004, the communication apparatus 200 determines whether another apparatus has been detected. If the other apparatus has been detected, the process advances to step S1005. Otherwise, the process returns to step S1000.

In step S1005, the communication apparatus 200 performs the processes “until capability inquiry” to the detected sink apparatus. These processes “until capability inquiry” correspond to the procedural steps until step S308 in FIG. 3. In step S1006, the communication apparatus 200 determines whether the first configuration is possible. In the operation example 1, for example, these processes are for confirming whether the detected speaker has the “Surround.Back/R” capability necessary to implement the first configuration. If the detected speaker has this capability, the process advances to step S1007. Otherwise, the process returns to step S1004.

In step S1007, the communication apparatus 200 executes playback in the first configuration and shifts to a state of “performing playback in the first configuration of the source” (step S950).

FIG. 11 is an operation flowchart of a case in which the communication apparatus 200 operates as a sink apparatus. It corresponds to the aforementioned description about the operation of the sink apparatus given in the operation example 4. That is, the operation of the sink apparatus described in FIG. 8 has been written in a flowchart format.

In step S1101, the communication apparatus 200 determines whether an operation to start operating as a sink apparatus of an audio or video (AV) service has been performed by the user. If it is determined that the operation to start operating as a sink apparatus has been performed, the process advances to step S1102. Otherwise, the process shifts to the aforementioned initial state (step S900) of FIG. 9A.

In step S1102, the communication apparatus 200 displays that it “can stand by for a request from a source apparatus”. In step S1103, the communication apparatus 200 performs an operation to detect whether there is a connection request from a source apparatus. If a connection request is detected, the process advances to step S1104. Otherwise, the process returns to step S1102.

In step S1104, the communication apparatus 200 displays “connection has been requested”. In step S1105, the communication apparatus 200 determines whether an operation to accept the detected connection request has been performed by the user. If the operation has been performed, the process advances to step S1106. Otherwise, the process returns to step S1104.

In step S1106, the communication apparatus 200 performs the processes “until parameter setting” with the source apparatus that transmitted the connection request. In step S1107, the communication apparatus 200 determines whether an operation to start the service (for example, displaying an image transmitted from the source apparatus) has been performed. If the operation has been performed, the process advances to step S1108. Otherwise, the process returns to step S1102.

In step S1108, the communication apparatus 200 plays back the audio or the video transmitted and received from the source apparatus. In step S1109, the communication apparatus 200 accepts a selection, from the user, as to whether to further stand by for a connection request from yet another source apparatus. If the user selects the operation for standby, the process returns to step S1103. Note that, it is possible to configure the process to return to the initial state in the aforementioned steps S1103, S1105, S1107, and S1109.

As described above, according to the first embodiment, it is possible to provide a better playback environment for the user in an audio video (AV) system using one-to-many communication connection. For example, even in a case in which connection cannot be established with some of the apparatuses, it is possible to perform playback with little sense of incongruity. In addition, since an already established session with an apparatus is used, there is no wasteful and mandatory wait time for the user.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-052968, filed Mar. 16, 2016, which is hereby incorporated by reference herein in its entirety.

What is claimed is:

1. A content transmission apparatus comprising:
an accepting unit configured to accept an instruction for content playback using a plurality of other communication apparatuses;
a determination unit configured to determine that communication connection cannot be established with some other communication apparatuses of the plurality of the other communication apparatuses; and
a notification unit configured to perform a predetermined notification to a user in response to determination by the determination unit that the communication connection cannot be established with the some other communication apparatuses of the plurality of the other communication apparatuses.

2. The apparatus according to claim 1, further comprising a control unit configured to control, if it is determined by the determination unit that the communication connection cannot be established with the some other communication apparatuses, so as to perform content playback using at least some other communication apparatuses that have already established communication connection.

3. The apparatus according to claim 2, wherein the control unit performs control, upon performing content playback using the at least some other communication apparatuses that have already established communication connection, to pause other communication apparatuses not used for the content playback of the other communication apparatuses that have already established communication connection.

4. The apparatus according to claim 2, further comprising:
a storage unit configured to store a table defining a plurality of configurations of the other communication apparatuses for content playback; and
a selecting unit configured to select one configuration of the configurations included in the table based on role information in the content playback of the other communication apparatuses that have already established communication connection,
wherein the control unit performs, upon performing content playback using the at least some other communication apparatuses that have already established communication connection, the content playback based on a configuration selected by the selecting unit.

5. The apparatus according to claim 2, wherein the predetermined notification is a notification to inquire of a user whether to perform content playback, and
the control unit controls to perform content playback in accordance with a result of the inquiry.

6. The apparatus according to claim 1, wherein the predetermined notification is an error notification indicating that communication connection cannot be established with the some other communication apparatuses of the plurality of other communication apparatuses.

7. The apparatus according to claim 2, wherein if new connection is established with another communication apparatus while content playback is performed by the control unit, the determination unit performs determination again.

8. A control method of a content transmission apparatus, comprising:
accepting an instruction for content playback using a plurality of other communication apparatuses;
determining that communication connection cannot be established with some other communication apparatuses of the plurality of the other communication apparatuses; and
performing a predetermined notification to a user in response to determination in the determining that the communication connection cannot be established with the some other communication apparatuses of the plurality of the other communication apparatuses.

9. A non-transitory computer-readable recording medium storing a program that causes a computer to function as a content transmission apparatus comprising:
an accepting unit configured to accept an instruction for content playback using a plurality of other communication apparatuses;
a determination unit configured to determine that communication connection cannot be established with some other communication apparatuses of the plurality of the other communication apparatuses; and
a notification unit configured to perform a predetermined notification to a user in response to determination by the determination unit that the communication connection cannot be established with the some other communication apparatuses of the plurality of the other communication apparatuses.
